(19) United States
(12) Patent Application Publication
(10) Pub. No.: US 2015/0358376 A1
(43) Pub. Date: Dec. 10, 2015

(54) Method, Apparatus and System for Transmitting Media Data

(71) Applicant: Huawei Technologies Co., Ltd., Shenzhen (CN)

(72) Inventors: Yuqun Fan, Shenzhen (CN); Lei Zhou, Shenzhen (CN)

(21) Appl. No.: 14/830,610

(22) Filed: Aug. 19, 2015

Related U.S. Application Data
(63) Continuation of application No. PCT/CN2013/084142, filed on Sep. 25, 2013.

(30) Foreign Application Priority Data
May 28, 2013 (CN) 201310203923.2

(51) Int. Cl. H04L 29/06; G06F 17/30; G06F 17/27; H04W 72/08

(52) U.S. Cl. CPC H04L 65/60; H04W 72/087; G06F 17/3082; G06F 17/2705

(57) ABSTRACT

A method for transmitting media data, where the method includes acquiring media quality information, acquiring a user quality of experience target of a user equipment, obtaining a transmission requirement of the media data stream of the user equipment according to the media quality information and the user quality of experience target of the user equipment, and sending the transmission requirement of the media data stream of the user equipment and the media data stream to a data node, so that the data node sends the media data stream to the user equipment. The transmission method according to an embodiment of the present disclosure achieves an effect of guaranteeing user quality of experience with consumption of less system resources. The present disclosure also discloses an apparatus and a system for transmitting media data.

### CROSS-REFERENCE TO RELATED APPLICATION

This application is a continuation of International Application No. PCT/CN2013/084142, filed on Sep. 25, 2013, which claims priority to Chinese Patent Application No. 201310203923.2, filed on May 28, 2013, both of which are hereby incorporated by reference in their entireties.

### TECHNICAL FIELD

The present disclosure relates to wireless network communications in a communications system, and in particular to, a method, an apparatus, and a system for transmitting media data.

### BACKGROUND

Wireless communications is widely used around the world, which greatly facilitates communication between people. The wireless communications can provide various services, including voice calls and web page downloading. A typical wireless communications system or network, such as a Long Term Evolution (LTE) system, provides radio link connections for a plurality of user equipment (UE) in a cell by using a base station, so as to implement wireless communications. Such a radio connection usually uses a shared radio spectrum. As shown in FIG. 1, a base station uses a same radio frequency band to provide a wireless data communications service for a plurality of (two shown in the figure) UEs. Data downloaded by a UE from a server reaches the base station through the Internet, a Packet Data Network Gateway (P-GW), and a Serving Gateway (S-GW), and then is sent to the UE through the base station. Different from an old second-generation wireless communications system, such as a Global System for Mobile Communications (GSM), the LTE system supports only a packet switched (PS) connection and no longer supports a circuit switched (CS) connection. For the CS connection, a resource needs to be reserved to ensure data transmission; the reserved resource cannot be released even though a sending end has no data to transmit. For the PS connection, a resource does not need to be reserved, and therefore utilization efficiency of a radio spectrum can be improved. To provide different quality of service (QoS), the LTE system maps different services to different tunnels, so as to implement different processing. Nine different QoS characteristics are defined in the LTE. Delay and packet loss requirements of a video service are classified in a unified manner, without considering a characteristic of a video of the provided service: data volume and quality of the video both fluctuate. This video fluctuation characteristic leads to different delay and packet loss requirements at different moments during transmission of video data. For different delay and packet loss requirements, corresponding system resource allocation should also be different; therefore, the in which limited system resources are not allocated according to a characteristic of a video leads to low resource utilization, and a stable playing effect on a UE cannot be ensured.

A video transmission service in a wireless communications environment has been widely used with popularity of smartphones. Transmission technologies of video on demand, video on-live, or video conference services may be roughly divided into two types: one type is a traditional real-time transport protocol (RTP)/user datagram protocol (UDP)-based transmission technology, and the other type is hypertext transfer protocol (HTTP)/transport control protocol (TCP)-based Dynamic Adaptive Streaming over HTTP protocol (DASH) that emerges recently. Regardless of which technology is used during a transmission process, due to a characteristic of a video service that a data volume is large and a characteristic of wireless communications that resources are limited, in a case in which a plurality of users share a resource, video data loss or delay occurs frequently because wireless resources are insufficient and allocation is unreasonable, causing that user video experience cannot be ensured.

### SUMMARY

In view of this, to solve the foregoing problem, embodiments of the present disclosure provide a method, an apparatus, and a system for transmitting media data. According to the method, the apparatus, and the system in the embodiments of the present disclosure, on the basis of guarantee of user quality of experience (QoE), a scarceness characteristic of wireless resources is fully considered to implement optimization on allocation of the wireless resources, thereby achieving an effect of guaranteeing the user QoE with consumption of as few system resources as possible.

An embodiment in a first aspect of the present disclosure discloses a method for transmitting media data, where the method includes acquiring media quality information, where the media quality information indicates media quality of a media data stream; acquiring a user quality of experience target of a user equipment; obtaining a transmission requirement of the media data stream of the user equipment according to the media quality information and the user quality of experience target of the user equipment; and sending the transmission requirement of the media data stream of the user equipment and the media data stream to a data node, so that the data node sends the media data stream to the user equipment according to the transmission requirement of the media data stream of the user equipment.

According to the method for transmitting media data in the embodiment in the first aspect of the present disclosure, on the basis of guarantee of user QoE, a scarceness characteristic of wireless resources is fully considered to implement optimization on allocation of the wireless resources, thereby achieving an effect of guaranteeing the user QoE with consumption of as few system resources as possible.

In a first possible implementation manner of the embodiment in the first aspect of the present disclosure, the acquiring media quality information includes receiving a media presentation description file sent by a server, parsing the media presentation description file to obtain media quality information of each video segment of each code stream in the media data stream, or acquiring the media data stream, and parsing the acquired media data stream to obtain the media quality information of the media data stream.

With reference to a second possible implementation manner of the embodiment in the first aspect of the present disclosure in the foregoing embodiments, the acquiring a user quality of experience target of a user equipment includes acquiring the user quality of experience target of the user equipment by means of negotiation with the user equipment, or acquiring the user quality of experience target of the user equipment according to preset subscription information of the user equipment.

With reference to a third possible implementation manner of the embodiment in the first aspect of the present disclosure in the foregoing embodiments, the transmission requirement includes at least one of the following: a delay requirement and a packet loss requirement.

With reference to a fourth possible implementation manner of the embodiment in the first aspect of the present disclosure in the foregoing embodiments, when the transmission requirement includes the delay requirement, the obtaining a transmission requirement of the media data stream of the user equipment according to the media quality information and the user quality of experience target of the user equipment includes calculating, according to the media quality information, maximum user quality of experience that the media data stream can reach, and obtaining the delay requirement of the media data stream of the user equipment according to the user quality of experience target and the maximum user quality of experience.

With reference to a fifth possible implementation manner of the embodiment in the first aspect of the present disclosure in the foregoing embodiments, when the transmission requirement includes the packet loss requirement, the obtaining a transmission requirement of the media data stream of the user equipment according to the media quality information and the user quality of experience target of the user equipment includes calculating, according to the media quality information, maximum user quality of experience that the media data stream can reach, and obtaining the packet loss requirement of the media data stream of the user equipment according to the user quality of experience target and the maximum user quality of experience.

With reference to a sixth possible implementation manner of the embodiment in the first aspect of the present disclosure in the foregoing embodiments, after the acquiring media quality information, the method further includes acquiring play status information of the user equipment, and correspondingly, the obtaining a transmission requirement of the media data stream of the user equipment according to the media quality information and the user quality of experience target of the user equipment includes: obtaining the transmission requirement of the media data stream of the user equipment according to the media quality information, the play status information of the user equipment, and the user quality of experience target of the user equipment.

With reference to the sixth possible implementation manner of the embodiment in the first aspect of the present disclosure in the foregoing embodiments, the media play status information includes allowable play time of media temporarily stored by a player of the user equipment, and the obtaining the transmission requirement of the media data stream of the user equipment according to the media quality information, the play status information of the user equipment, and the user quality of experience target of the user equipment includes calculating, according to the media quality information, the maximum user quality of experience that the media data stream can reach, and obtaining the delay requirement of the media data stream of the user equipment according to the allowable play time of the media temporarily stored by the player of the user equipment, the user quality of experience target, and the maximum user quality of experience.

An embodiment in a second aspect of the present disclosure discloses an apparatus for transmitting media data, where the apparatus includes a media quality information acquiring module configured to acquire media quality information, where the media quality information indicates media quality of a media data stream; a user quality of experience target acquiring module configured to acquire a user quality of experience target of a user equipment; a media data delay calculating module configured to according to the media quality information obtained by the media quality information acquiring module and the user quality of experience target of the user equipment obtained by the user quality of experience target acquiring module, obtain a transmission requirement of the media data stream of the user equipment; and a sending module configured to send, to a data node, the transmission requirement of the media data stream of the user equipment obtained by the media data delay calculating module and the media data stream obtained by the media quality information acquiring module, so that the data node sends the media data stream to the user equipment according to the transmission requirement of the media data stream of the user equipment.

According to the apparatus for transmitting media data in the embodiment in the second aspect of the present disclosure, on the basis of guarantee of user QoE, a scarceness characteristic of wireless resources is fully considered to implement optimization on allocation of the wireless resources, thereby achieving an effect of guaranteeing the user QoE with consumption of as few system resources as possible.

In a first possible implementation manner of the embodiment in the second aspect of the present disclosure, the media quality information acquiring module includes a receiving unit and a parsing unit, where the receiving unit is configured to receive a media presentation description file sent by a server, and the parsing unit is configured to parse the media presentation description file received by the receiving unit to obtain media quality information of each video segment of each code stream in the media data stream, or the receiving unit is configured to receive the media data stream, and the parsing unit is configured to parse the media data stream received by the receiving unit to obtain the media quality information of the media data stream.

With reference to a second possible implementation manner of the embodiment in the second aspect of the present disclosure in the foregoing embodiments, the user quality of experience target acquiring module is configured to acquire the user quality of experience target of the user equipment by means of negotiation with the user equipment, or acquire the user quality of experience target of the user equipment according to preset subscription information of the user equipment.

With reference to a third possible implementation manner of the embodiment in the second aspect of the present disclosure in the foregoing embodiments, the transmission requirement includes at least one of the following: a delay requirement and a packet loss requirement.

With reference to a fourth possible implementation manner of the embodiment in the second aspect of the present disclosure in the foregoing embodiments, when the transmission requirement includes the delay requirement, the media data delay calculating module is configured to calculate, according to the media quality information, maximum user quality of experience that the media data stream can reach, and obtain the delay requirement of the media data stream of the user equipment according to the user quality of experience target and the maximum user quality of experience.

With reference to a fifth possible implementation manner of the embodiment in the second aspect of the present disclosure in the foregoing embodiments, when the transmission requirement includes the packet loss requirement, the media data delay calculating module is configured to calculate, according to the media quality information, maximum user quality of experience that the media data stream can reach, and obtain the packet loss requirement of the media data stream of the user equipment according to the user quality of experience target and the maximum user quality of experience.

With reference to a sixth possible implementation manner of the embodiment in the second aspect of the present disclosure in the foregoing embodiments, the apparatus further includes a user play status information acquiring module configured to acquire play status information of the user equipment, and correspondingly, the media data delay calculating module is configured to obtain the transmission requirement of the media data stream of the user equipment according to the media quality information, the play status information of the user equipment, and the user quality of experience target of the user equipment.

With reference to a seventh possible implementation manner of the embodiment in the second aspect of the present disclosure in the foregoing embodiments, the media play status information includes allowable play time of media temporarily stored by a player of the user equipment, and the media data delay calculating module is configured to calculate, according to the media quality information, the maximum user quality of experience that the media data stream can reach, and obtain the delay requirement of the media data stream of the user equipment according to the allowable play time of the media temporarily stored by the player of the user equipment, the user quality of experience target, and the maximum user quality of experience.

An embodiment in a third aspect of the present disclosure discloses a system for transmitting media data, where the transmission system includes a server and a base station, where the base station includes the apparatus for transmitting media data according to any item of the embodiment in the second aspect of the present disclosure.

An embodiment in a fourth aspect of the present disclosure discloses a system for transmitting media data, where the transmission system includes a server, a base station, and a data network gateway, where the data network gateway includes the apparatus for transmitting media data according to any item of the embodiment in the second aspect of the present disclosure.

An embodiment in a fifth aspect of the present disclosure discloses a system for transmitting media data, where the transmission system includes a server, a base station, and a data network gateway, where the data network gateway includes a media quality information acquiring module and a user quality of experience target acquiring module, where the media quality information acquiring module is configured to acquire media quality information, and the user quality of experience target acquiring module is configured to acquire a user quality of experience target from a user equipment, and the base station includes a media data delay calculating module, where the media data delay calculating module is configured to obtain a delay requirement of a media data stream of the user equipment according to the media quality information and the user quality of experience target.

With reference to a possible implementation manner of the embodiment in the fifth aspect of the present disclosure, the data network gateway further includes a user play status information acquiring module, where the user play status information acquiring module is configured to acquire play status information of the user equipment; and correspondingly, the media data delay calculating module is configured to obtain the delay requirement of the media data stream of the user equipment according to the media quality information, the play status information of the user equipment, and the user quality of experience target.

According to the system for transmitting media data in the embodiment in the third, fourth, or fifth aspect of the present disclosure, on the basis of guarantee of user QoE, a scarceness characteristic of wireless resources is fully considered to implement optimization on allocation of the wireless resources, thereby achieving an effect of guaranteeing the user QoE with consumption of as few system resources as possible.

### BRIEF DESCRIPTION OF DRAWINGS

To describe the technical solutions in the embodiments of the present disclosure or more clearly, the following briefly introduces the accompanying drawings required for describing the embodiments or the. The accompanying drawings in the following description show merely some embodiments of the present disclosure, and a person of ordinary skill in the art may still derive other drawings from these accompanying drawings without creative efforts.

FIG. 1 is a schematic structural diagram of a wireless communications system, FIG. 2 is a flowchart of a method for transmitting media data according to an embodiment of the present disclosure.

FIG. 3 is a flowchart of another method for transmitting media data according to an embodiment of the present disclosure.

FIG. 4 is a structural diagram of an apparatus for transmitting media data according to an embodiment of the present disclosure.

FIG. 5 is a structural diagram of a system for transmitting media data according to an embodiment of the present disclosure.

FIG. 6 is a structural diagram of another system for transmitting media data according to an embodiment of the present disclosure.

FIG. 7 is a structural diagram of another system for transmitting media data according to an embodiment of the present disclosure.

### DESCRIPTION OF EMBODIMENTS

The following clearly describes the technical solutions in the embodiments of the present disclosure with reference to the accompanying drawings in the embodiments of the present disclosure. The described embodiments are merely a part rather than all of the embodiments of the present disclosure. All other embodiments obtained by a person of ordinary skill in the art based on the embodiments of the present disclosure without creative efforts shall fall within the protection scope of the present disclosure.

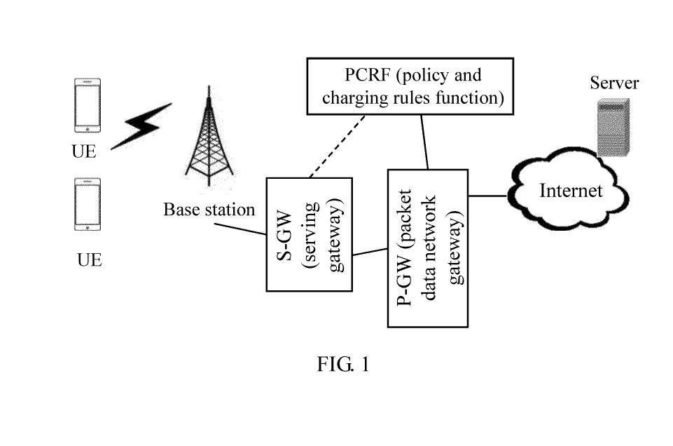

Wireless communications can provide various services, including voice calls, and web page downloading. A typical wireless communications system or network, such as a LTE system, provides radio links for a plurality of UE in a cell by using a base station, so as to implement wireless communications. Such a radio connection usually uses a shared radio spectrum. FIG. 1 shows a basic LTE system architecture.

Data transmission may refer to that a user equipment sends a request to a base station or refer to that the base station actively sends data to the user equipment. That a UE sends a request is used as an example. The data request is sent to devices such as a serving gateway S-GW and a packet data network gateway P-GW through a base station, and then sent to a server; the server finds related data according to the request of the user equipment, and sends the related data to the base station through the packet data network gateway and the serving gateway; the base station sends the related data to the user equipment, to complete data transmission.

A method for transmitting media data according to an embodiment of the present disclosure is described below according to FIG. 2. As shown in FIG. 2, the method includes S21: Acquire media quality information, where the media quality information indicates media quality of a media data stream.

The acquired media quality information is used to indicate quality of media data, and a measurement parameter thereof may be, for example, a peak signal to noise ratio (PSNR) or the like.

The media quality information may be used to indicate compression quality of the media data, or may be used to indicate quality of experience of the media data.

In an embodiment of the present disclosure, a specific method for acquiring the media quality information is receiving a media presentation description file sent by a media server that stores the media data, where the media presentation description file includes the media quality information of the media data, and parsing the media presentation description file to obtain the media quality information of the media data, or receiving the media data stream first, and then analyzing the media data stream to obtain the media quality information.

In an embodiment of the present disclosure, it may be understood that, acquiring the media data stream in this step is not a necessary step for acquiring the media quality information, the media quality information may also be acquired in the foregoing manner of parsing the media presentation description (MPD) file, and analyzing the media data stream is merely an implementation manner of acquiring the media quality information.

In an embodiment of the present disclosure, in a DASH service application environment, a user terminal first requests a media presentation description file MPD on a server, and video quality information, such as a PSNR value, of each video segment in each representation can be added to the MPD. The PSNR value may be used to indicate quality of the video segment.

The quality of the media data may be acquired according to the video quality information carried in the MPD; or the media quality information of the media data stream may be obtained by parsing the acquired media data stream.

In a specific embodiment, the media quality information may be acquired by analyzing payload data of the media data stream, for example, may be acquired by analyzing quality information that may be included in a file format or analyzing a bit stream of video data; or the media quality information may be acquired by using another file. It may be understood that, this embodiment is only an example used to help understand the embodiments of the present disclosure, and shall not be construed as a specific limitation to the embodiments of the present disclosure.

S22: Acquire a user quality of experience target of a user equipment.

The user quality of experience target is quality of experience expected by a user, and a measurement parameter thereof may be, for example, a mean opinion score (MOS) or the like. Acquiring the user quality of experience target of the user includes: acquiring the user quality of experience target of the user by means of negotiation with the user, or acquiring the user quality of experience target of the user according to preset subscription information of the user.

For a DASH service, a QoE function unit on a network may negotiate, according to quality information of an entire video, with a user terminal about a QoE target value of a video service, that is, the quality of experience expected by the user. Because a same video in the DASH service may have a plurality of code streams with different quality, the target value cannot exceed highest quality that each video code stream saved under normal play (that is, play without any loss and any delay) can reach; otherwise, the QoE target value cannot be reached.

S23: Obtain a transmission requirement of the media data stream of the user equipment according to the media quality information and the user quality of experience target of the user equipment.

User quality of experience that can be reached when a media video code stream is played without any loss and any delay may be calculated according to the media quality information acquired in S21, such as a PSNR. For example, the user quality of experience is calculated according to the following formula QoE₀=k×(a−b/PSNR), where k, a, and b are all constant coefficients. In an embodiment of the present disclosure, if k=0.56, a=14.2, and b=280.5, QoE0 is the user quality of experience during the play without any loss and any delay. Another empirical formula may also be used to calculate the user quality of experience, or individualized fine-tuning is performed for a single user equipment.

However, in actual application, actual user quality of experience may also be affected by a transmission delay or a packet loss, and the actual user quality of experience may be calculated by using the following formula QoE=QoE₀−k₁×delay−k₂×packloss, where k1 and k2 are constants. In an embodiment of the present disclosure, if k1=0.005, k2=3.6, delay is a delay of a media data packet, and packloss is a transmission packet loss rate of the media data packet, QoE is actual quality of experience sensed by a user. The actual user quality of experience may also be calculated by using a formula related to QoE calculation specified in an international standard, such as the recommendation International Telecommunication Union Telecommunication Standardization Section ITU-T P.1202. To ensure that user quality of experience reaches the user quality of experience target acquired in S22, which is assumed to be QoE_{obj}, on the premise that a transmission packet loss rate of a media data packet is zero or is negligible (for example, 10-8), a delay requirement of the media data packet can be calculate by using the following formula D=T−P+(QoE₀−QoE_{obj})/k₁, where D indicates a calculated delay of the media data packet, T indicates a corresponding play presentation time stamp (PTS) of the data packet in an entire media stream, P indicates a period of time for which current media is already played, QoE0 is user quality of experience during play without any loss and any delay, QoEobj is the user quality of experience target acquired in S22, and k1 is the foregoing constant.

A formula for calculating the delay of the media data packet may be as follows D=T−P+b×c^{QoE}^{₀}^{-QoE}^{_{obj}}, where D indicates the calculated delay of the media data packet, T indicates the corresponding play PTS of the data packet in the entire media stream, P indicates the period of time for which the current media is already played, QoE0 is the user quality of experience during the play without any loss and any delay, QoEobj is the user quality of experience target acquired in S22, and b and c are constants. Based on some statistical data, it may be set that b=10 and c=10.

In a case in which a delay is ensured, for example, D=T−P, that is, the media data packet can be transmitted to a media playing device, such as a media player of the user equipment, before a media playing moment, a network system may also use the following formula to calculate a packet loss requirement of the media data packet plossₘₐₓ=(QoE₀−QoE_{obj})/k₂, where plossmax indicates a maximum allowable packet loss rate, QoE0 is the user quality of experience during the play without any loss and any delay, QoEobj is the user quality of experience target acquired in S22, and k2 is a constant. A formula for calculating the packet loss rate may be as follows plossₘₐₓ=e^{QoE}^{₀}^{-QoE}^{_{obj}}^{)/c}−1, where plossmax indicates the maximum allowable packet loss rate, QoE0 is the user quality of experience during the play without any loss and any delay, QoEobj is the user quality of experience target acquired in S22, c is a constant, and c=21.

In an embodiment of the present disclosure, the foregoing formulas need to be executed for each media data packet of each user in a wireless cell; a system may also simultaneously calculate delay and packet loss requirements of media data packets in a case in which some media data packets are lost and it cannot be ensured that the media data packets are transmitted to a media playing device before a media playing moment.

For a formula for calculating a delay and a packet loss, reference may be made to the foregoing formulas, and may also be made to any mathematical model or formula related to QoE, for example, calculation may be performed by using a model or formula related to QoE calculation and specified in the recommendation ITU-T P.1202.

S24: Send the transmission requirement of the media data stream of the user equipment and the media data stream to a data node, so that the data node sends the media data stream to the user equipment according to the transmission requirement of the media data stream of the user equipment.

In an embodiment of the present disclosure, the data node includes but is not limited to a P-GW, an S-GW, a mobility management entity (MME), a policy and charging rules function (PCRF), an home subscriber server (HSS)/Authentication, Authorization and Accounting (AAA) service processor (SPR), a base station, or the like, and the data node mainly implements a function of guaranteeing quality of experience of a user media service.

In an embodiment of the present disclosure, with reference to the delay or packet loss requirement of the media data packet acquired in S23, the base station may use a transmission algorithm, such as proportional fairness scheduling (PFS), to transmit the data packet. The base station may set a queue length threshold. When a queue length of data of a user waiting to be transmitted exceeds the queue length threshold and a media data packet is allowed to be lost, that is, the maximum allowable packet loss rate is not zero, packet loss is executed. During PFS calculation, the base station may perform delay weighting for calculation of each user.

w=log(1.1+wt/5D), where w is a weighted value for a user, wt is a period of time for which a media data packet of the user has waited, and D is the delay of the media data packet calculated in S23.

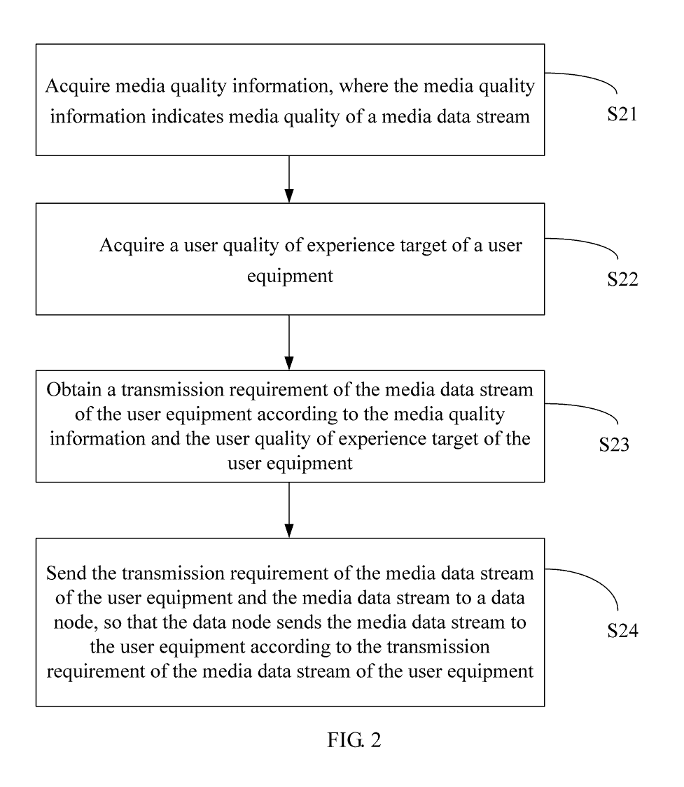

A method for transmitting media data according to an embodiment of the present disclosure is described below with reference to FIG. 3. As shown in FIG. 3, the method includes S31: Acquire a user quality of experience target and media quality information.

For a method of acquiring the foregoing information, reference may be made to the method provided in the embodiment in FIG. 2.

S32: Acquire play status information of a user equipment.

The acquired play status information of the user equipment includes allowable play time of media temporarily stored in a buffer area of a player of the user equipment. In an embodiment of the present disclosure, the acquired play status information of the user equipment further includes a play status of the player of the user equipment, such as paused, playing, and the like. A manner of acquiring the foregoing information is negotiation with the user equipment, that is, the user equipment reports the foregoing information in a specific time triggering or event triggering manner. The allowable play time of the media temporarily stored in the buffer area of the player of the user equipment may also be estimated by a QoE function unit or another entity, such as a base station, according to a PTS of a sent media data packet and provisioning time of a media service. An estimation formula may be as follows B=T−P where B is the allowable play time of the media temporarily stored in the buffer area of the player of the user equipment, and T is a maximum value of a PTS of a media data packet sent to the user equipment, and P is a period of time for which the media is already played.

S33: Calculate a delay or packet loss requirement of a media data packet according to the user quality of experience target, the media quality information, and the play status information of the user equipment.

User quality of experience that can be reached when a media video code stream is played without any loss and any delay may be calculated according to the media quality information acquired in S31, such as a PSNR. For example, the user quality of experience is calculated according to the following formula QoE₀=k×(a−b/PSNR), where k, a, and b are all constant coefficients; if k=0.56, a=14.2, and b=280.5, QoE0 is the user quality of experience during the play without any loss and any delay. Another empirical formula may also be used to calculate the user quality of experience, or individualized fine-tuning is performed for a single user.

Actual user quality of experience may also be affected by a transmission delay or a packet loss, and the actual user quality of experience may be calculated by using the following formula QoE=QoE₀−k₁×delay−k₂×packloss, where k1 and k2 are constants; based on some statistical analysis, k1=0.005, and k2=3.6; delay is a delay of a media data packet, packloss is a transmission packet loss rate of the media data packet, and QoE is actual quality of experience sensed by a user. To ensure that user quality of experience reaches the user quality of experience target acquired in S31, which is assumed to be QoEobj, on the premise that a transmission packet loss rate of a media data packet is zero or is negligible (for example, 10-8), a delay requirement of the media data packet can be calculate by using the following formula D=B+(QoE₀−QoE_{obj})/k₁, where D indicates a calculated delay of the media data packet, B is the allowable play time of the media temporarily stored in the buffer area of the player of the user equipment and acquired in S32, QoE0 is user quality of experience during play without any loss and any delay, QoEobj is the user quality of experience target acquired in S31, and k1 is the foregoing constant.

A formula for calculating the delay of the media data packet may be as follows D=B+b×c^{QoE}^{₀}^{-QoE}^{_{obj}}, where D indicates the calculated delay of the media data packet, B is the allowable play time of the media temporarily stored in the buffer area of the player of the user equipment and acquired in S32, QoE0 is the user quality of experience during the play without any loss and any delay, QoEobj is the user quality of experience target acquired in S31, and b and c are constants. Based on some statistical data, it may be set that b=10 and c=10.

If the user player is in a paused state in the user player status information acquired in S32, a delay of the media data packet may be adjusted according to the foregoing calculated delay, for example, the delay is set to be twice as many as the foregoing calculated delay.

In a case in which a delay is ensured, for example, D=B, that is, a media data packet can be transmitted to a media playing device, such as a media player of the user equipment, before a media playing moment, a system may also use the following method to calculate a packet loss requirement of the media data packet plossₘₐₓ=(QoE₀−QoE_{obj})/k₂, where plossmax indicates a maximum allowable packet loss rate, QoE0 is the user quality of experience during the play without any loss and any delay, QoEobj is the user quality of experience target acquired in S22, and k2 is the foregoing constant. A formula for calculating the packet loss rate may be as follows, plossₘₐₓ=e^{QoE}^{₀}^{-QoE}^{_{obj}}^{/c}−1, where plossmax indicates the maximum allowable packet loss rate, QoE0 is the user quality of experience during the play without any loss and any delay, QoEobj is the user quality of experience target acquired in S22, c is a constant, and c=21.

The foregoing formulas need to be executed for each media data packet of each user in a wireless cellular cell; a system may also simultaneously calculate delay and packet loss requirements of media data packets in a case in which some media data packets are lost and it cannot be ensured that the media data packets are transmitted to a media playing device before a media playing moment.

For a formula for calculating a delay and a packet loss, reference may be made to the foregoing formulas, and may also be made to any mathematical model or formula related to QoE, for example, calculation may be performed by using a model or formula in the recommendation ITU-T P.1202.

S34: Transmit data according to the calculated delay or packet loss requirement of the media data packet.

In an embodiment of the present disclosure, the data node may be devices such as a base station, a data network gateway, and a serving gateway. It may be understood that, the examples of the device type of the data node are only used to help understand this embodiment of the present disclosure, and shall not be construed as a specific limitation to this embodiment of the present disclosure.

It may be understood that, the foregoing sequence of the operations of acquiring the parameters can be modified, and the sequence provided herein is only an example used to help understand this embodiment of the present disclosure and is not a limitation to the acquisition of the parameters required for calculation.

According to the method for transmitting media data in this embodiment of the present disclosure, on the basis of guarantee of user QoE, a scarceness characteristic of wireless resources is fully considered to implement optimization on allocation of the wireless resources, thereby achieving an effect of guaranteeing the user QoE with consumption of as few system resources as possible.

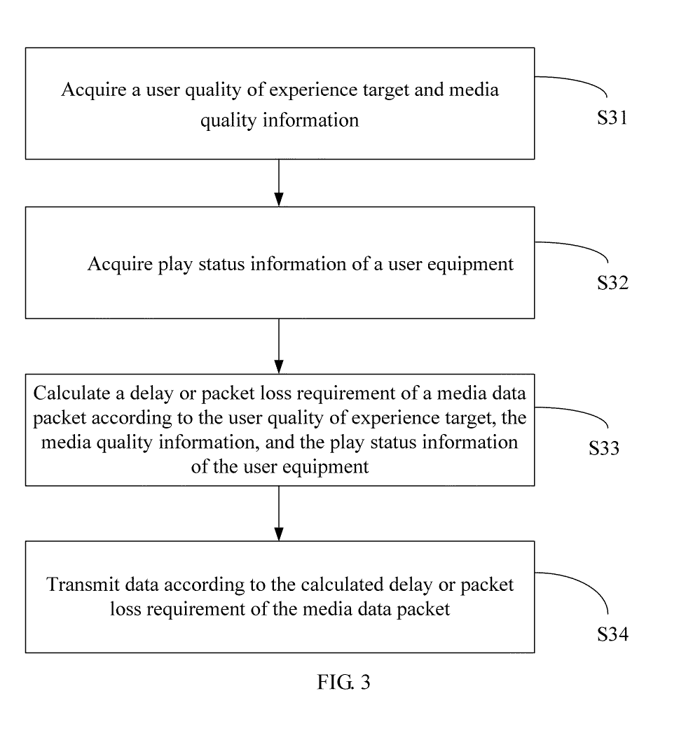

An apparatus 40 for transmitting media data according to an embodiment of the present disclosure is described below according to FIG. 4. As shown in FIG. 4, the apparatus 40 includes a media quality information acquiring module 410, a user quality of experience target acquiring module 420, a media data delay calculating module 440, and a sending module 450, where the media data delay calculating module 440 is separately connected to the media quality information acquiring module 410, the user quality of experience target acquiring module 420, and the sending module 450.

The media data delay calculating module 440 is configured to: according to media quality information obtained by the media quality information acquiring module 410 and a user quality of experience target of a user equipment obtained by the user quality of experience target acquiring module 420, obtain a transmission requirement of a media data stream of the user equipment.

The sending module 450 is configured to send, to a data node, the transmission requirement of the media data stream of the user equipment obtained by the media data delay calculating module and the media data stream obtained by the media quality information acquiring module, so that the data node sends the media data stream to the user equipment according to the transmission requirement of the media data stream of the user equipment.

For manners of acquiring corresponding information by the media quality information acquiring module 410 and the user quality of experience target acquiring module 420, reference may be made to the foregoing method embodiments and details are not described herein again.

For a manner of calculating a transmission requirement of a media data packet by the media data delay calculating module 440, reference may be made to the foregoing method embodiments and details are not described herein again.

In an embodiment of the present disclosure, the media quality information acquiring module 410 includes a receiving unit 4101 and a parsing unit 4102, where the receiving unit 4101 is configured to receive a media presentation description file sent by a server, and the parsing unit 4102 is configured to parse the media presentation description file received by the receiving unit 4101 to obtain media quality information of each video segment of each code stream in the media data stream, or the receiving unit 4101 is configured to receive the media data stream, and the parsing unit 4102 is configured to parse the media data stream received by the receiving unit 4101 to obtain media quality information of the media data stream.

In an embodiment of the present disclosure, the apparatus 40 further includes a user play status information acquiring module 430, where the user play status information acquiring module 430 is connected to the media data delay calculating module 440 and is configured to acquire play status information of the user equipment.

For a specific manner of acquiring the play status information of the user equipment, reference may be made to the foregoing method embodiments and details are not described herein again.

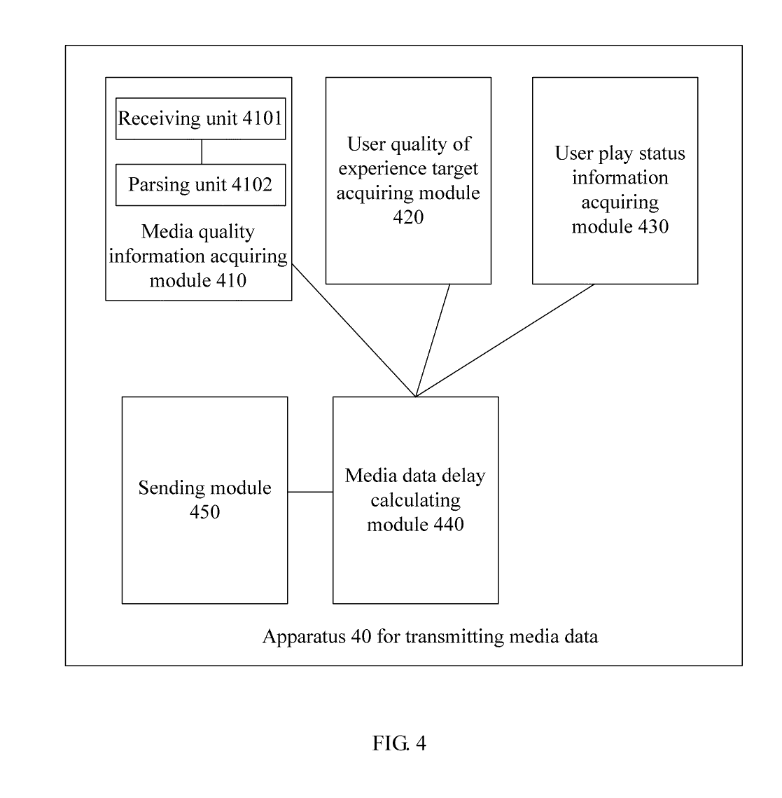

In an embodiment of the present disclosure, as shown in FIG. 5, an apparatus 50 for ensuring user experience of a media service is added on a base station in an existing LTE system architecture. The apparatus 50 may be the apparatus for ensuring user experience of a media service shown in FIG. 4, the apparatus may be deployed in any functional entity of a core network and an access network, which includes but is not limited to a P-GW, an S-GW, an MME, a PCRF, an HSS/AAA SPR, a base station, or and the like, and the apparatus mainly implements a function of guaranteeing quality of experience of a user media service. A specific working process is described below.

A user quality of experience target and media quality information are acquired.

The acquired media quality information may be quality of media data, and a measurement parameter thereof may be, for example, a PSNR or the like. The acquiring of the media quality information may be completed by the media quality information acquiring module 410 in FIG. 4, and this module receives and analyzes a media presentation description file or a media data stream and outputs media quality information.

In an embodiment of the present disclosure, the media quality information acquiring module 410 includes a receiving unit 4101 and a parsing unit 4102, where the receiving unit 4101 is connected to the parsing unit 4102. The receiving unit 4101 is configured to receive a media presentation description file MPD sent by a server, where the media presentation description file includes media quality information of each media segment of each representation in media, such as a PSNR; the parsing unit 4102 is configured to parse the media presentation description file to obtain media quality of the media data.

In an embodiment of the present disclosure, the media quality information acquiring module 410 is configured to: parse a valid payload of the media data, for example, parse media quality information that may be included in a file format or analyze a bitstream of the media data; and obtain the media quality of the media data according to valid payload.

In an embodiment of the present disclosure, the user quality of experience target needs to be acquired, this target is quality of experience expected by a user, and a measurement parameter thereof may be, for example, a MOS or the like. The acquiring of the user quality of experience target is completed by the user quality of experience target acquiring module 420 in FIG. 4, and this module analyzes user subscription information or negotiates with a user equipment about a QoE target, and outputs the QoE target of the user.

Play status information of the user equipment is acquired.

In an embodiment of the present disclosure, a user equipment play status information acquiring module 430 is configured to acquire media play status information of the user equipment, which includes but is not limited to allowable play time of media temporarily stored in a buffer area of a player of the user equipment and actions such as pausing and playing performed by the user on the player. This module receives and analyzes delivery information of user video data or player status information fed back by a user terminal, and outputs user player status information.

In an embodiment of the present disclosure, the user play status information acquiring module 430 includes: a first acquiring unit 4301 configured to acquire initial time and current time of play of a media service of the user equipment, and configured to acquire a video segment of a code stream in the currently transmitted media data stream; and a first calculating unit 4302 configured to obtain play time of the user media service according to the initial time and the current time, and configured to obtain the allowable play time of the media temporarily stored in a buffer of the player of the user equipment according to player time and a PTS of the video segment of the code stream in the currently transmitted media data stream.

In an embodiment of the present disclosure, for a method of calculating the allowable play time of the media temporarily stored in the buffer of the user equipment, reference may be made to the description in the foregoing embodiments and details are not described herein again.

A delay or packet loss requirement of a media data packet is calculated according to the user quality of experience target, the media quality information, and the play status information of the user equipment.

In an embodiment of the present disclosure, a media data delay calculating module 440 calculates a proper delay or packet loss requirement of the user media data packet in real time according to the media quality information, the user quality of experience target, and the user player status information. For a specific method of calculating the delay or packet loss requirement, reference may be made to the description in the foregoing embodiments and details are not described herein again.

The base station performs transmission according to the calculated delay or packet loss requirement of the media data packet.

In an embodiment of the present disclosure, a base station 51 performs transmission according to the foregoing calculated delay or packet loss requirement. For a specific transmission method, reference may be made to the description in the foregoing embodiments and details are not described herein again.

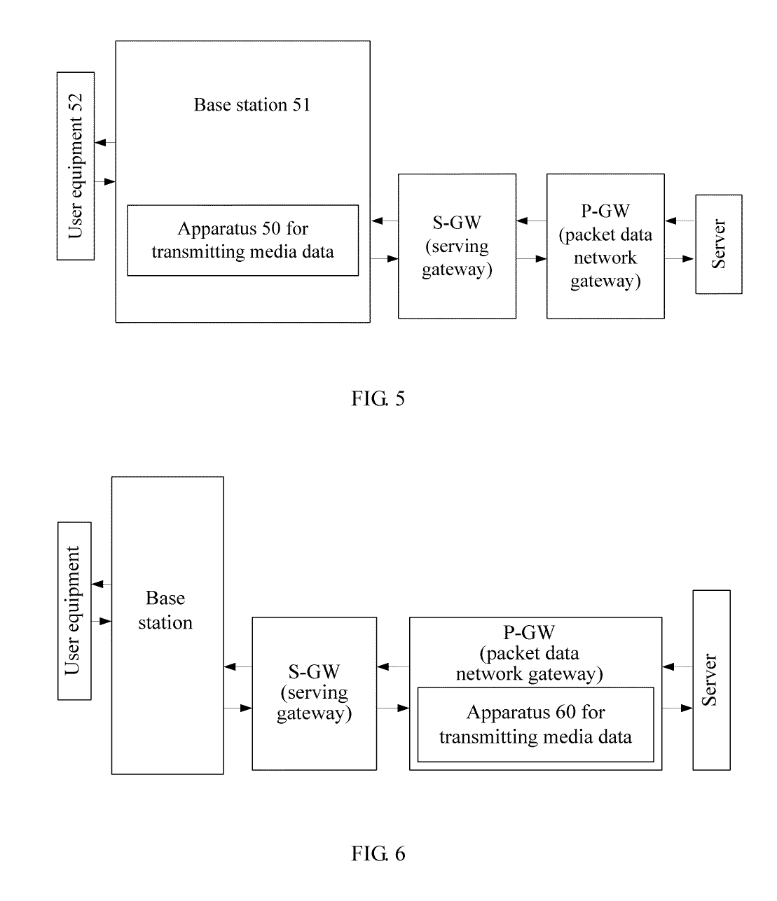

An apparatus 60 that is for ensuring user experience of a media service and is added on a P-GW on a core network is described below with reference to FIG. 6. The apparatus 60 may be the apparatus for ensuring user experience of a media service shown in FIG. 4. The apparatus mainly implements a function of guaranteeing quality of experience of a user media service. A specific working process is described below.

A user quality of experience target and media quality information are acquired.

For the acquiring of the user quality of experience target and the media quality information, reference may be made to the description in the foregoing embodiments and details are not described herein again.

Play status information of a user equipment is acquired.

For the acquiring of the play status information of the user equipment, reference may be made to the description in the foregoing embodiments and details are not described herein again.

A delay or packet loss requirement of a media data packet is calculated according to the user quality of experience target, the media quality information, and the play status information of the user equipment.

For a specific method of calculating the delay or packet loss requirement, reference may be made to the description in the foregoing embodiments and details are not described herein again.

A base station performs transmission according to the calculated delay or packet loss requirement of the media data packet.

After a delay of the media data packet is calculated on the P-GW, it takes a period of time to transmit the media data packet to the base station. Therefore, time of the transmission needs to be considered when the base station performs the transmission. Reference may be made to the following specific method. After the delay requirement of the data packet is calculated on the P-GW, a transmission end time stamp of the data packet is calculated according to a current system time stamp. A calculation formula may be as follows T_{d}=T_{c}+D, where T_{d} is the transmission end time stamp, T_{c} is the current system time stamp, and D is the delay requirement of the media data packet. The transmission end time stamp may be transmitted with the media data packet from the P-GW to the base station by using a core network transmission protocol, such as the general packet radio service (GPRS) tunneling protocol (GTP) or the Proxy Mobile internet protocol (IP) Protocol (PMIP).

The base station calculates the delay requirement of the media data packet according to the transmission end time stamp and the current system time stamp. A calculation formula may be as follows D=T_{d}−T_{c}, where T_{d} is the transmission end time stamp, T_{c} is the current system time stamp, and D is the delay requirement of the media data packet.

For a specific transmission method, reference may be made to the description in the foregoing embodiments and details are not described herein again.

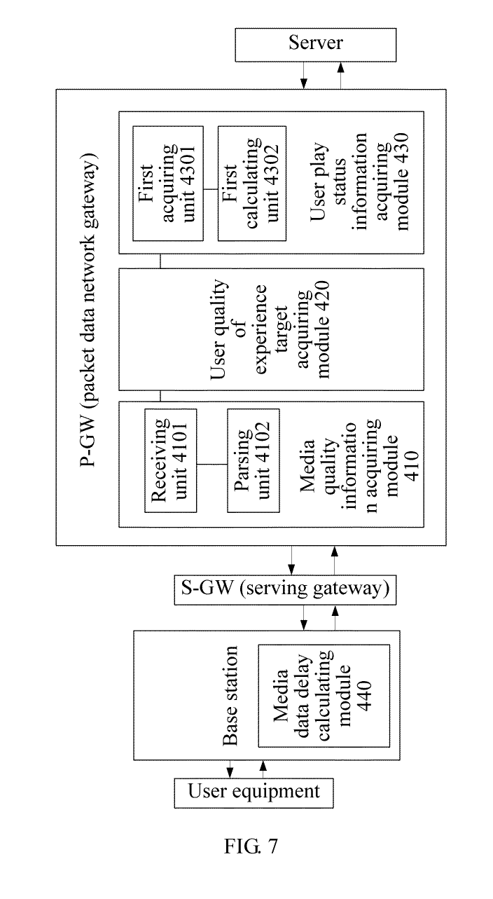

Modules in an apparatus for ensuring user experience of a media service may also be separately deployed on different function entities in an LTE system. With reference to FIG. 7, the following describes a media quality information acquiring module 410, a user quality of experience target acquiring module 420, and a user play status information acquiring module 430 in an apparatus 40 that is for ensuring user experience of a media service and is added on a P-GW on a core network, and a media data delay calculating module 440 in an apparatus 40 that is for ensuring user experience of a media service and is added on a base station. They mainly implement a function of guaranteeing quality of experience of a user media service. A specific working process is described below.

A user quality of experience target and media quality information are acquired.

For the acquiring of the user quality of experience target and the media quality information, reference may be made to the description in the foregoing embodiments and details are not described herein again.

Play status information of a user equipment is acquired.

For the acquiring of the play status information of the user equipment, reference may be made to the description in the foregoing embodiments and details are not described herein again.

A delay or packet loss requirement of a media data packet is calculated according to the user quality of experience target, the media quality information, and the play status information of the user equipment.

The user quality of experience target, the media quality information, and the play status information of the user equipment are acquired on the P-GW, and a media data delay and packet loss calculating module is on the base station. Therefore, the user quality of experience target, the media quality information, and the play status information of the user equipment need to be transmitted to and stored on the base station after being acquired on the P-GW.

For a specific method of calculating the delay or packet loss requirement, reference may be made to the description in the foregoing embodiments and details are not described herein again.

The base station transmits the media data packet according to the calculated delay or packet loss requirement of the media data packet.

For a specific method of transmitting the media data packet, reference may be made to the description in the foregoing embodiments and details are not described herein again.

It may be clearly understood by a person skilled in the art that, for the purpose of convenient and brief description, for a detailed working process of the foregoing base station, apparatus and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

In addition, functional units in the embodiments of the present disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present disclosure essentially, or the part contributing to the, or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of the present disclosure. The foregoing storage medium includes: any medium that can store program code, such as a universal serial bus (USB) flash drive, a removable hard disk, a read-only memory (ROM), a random access memory (RAM), a magnetic disk, or an optical disc.

The foregoing descriptions are merely exemplary implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claim is:

1. A method for transmitting media data, wherein the method comprises:
acquiring media quality information, wherein the media quality information indicates media quality of a media data stream;
acquiring a user quality of experience target of a user equipment;
obtaining a transmission requirement of the media data stream of the user equipment according to the media quality information and the user quality of the experience target of the user equipment; and
sending the transmission requirement of the media data stream of the user equipment to a data node, so that the data node sends the media data stream to the user equipment according to the transmission requirement of the media data stream of the user equipment.

2. The method according to claim 1, wherein acquiring the media quality information further comprises:
receiving a media presentation description file from a server;
parsing the media presentation description file to obtain media quality information of each video segment of each code stream in the media data stream.

3. The method according to claim 1, wherein acquiring the media quality information comprises:
acquiring the media data stream; and
parsing the media data stream to obtain the media quality information of the media data stream.

4. The method according to claim 1, wherein acquiring the user quality of the experience target of the user equipment comprises acquiring the user quality of the experience target of the user equipment by means of negotiation with the user equipment.

5. The method according to claim 1, wherein acquiring the user quality of the experience target of the user equipment comprises acquiring the user quality of the experience target of the user equipment according to preset subscription information of the user equipment.

6. The method according to claim 1, wherein the transmission requirement comprises at least one of the following: a delay requirement and a packet loss requirement.

7. The method according to claim 6, wherein when the transmission requirement comprises the delay requirement, obtaining the transmission requirement of the media data stream of the user equipment according to the media quality information and the user quality of experience target of the user equipment comprises:
calculating, according to the media quality information, maximum user quality of experience that the media data stream can reach; and
obtaining the delay requirement of the media data stream of the user equipment according to the user quality of experience target and the maximum user quality of experience.

8. The method according to claim 6, wherein when the transmission requirement comprises the packet loss requirement, obtaining the transmission requirement of the media data stream of the user equipment according to the media quality information and the user quality of experience target of the user equipment comprises:
calculating, according to the media quality information, maximum user quality of experience that the media data stream can reach; and
obtaining the packet loss requirement of the media data stream of the user equipment according to the user quality of experience target and the maximum user quality of experience.

9. The method according to claim 1, wherein after acquiring the media quality information, the method further comprises acquiring play status information of the user equipment, and wherein obtaining the transmission requirement of the media data stream of the user equipment according to the media quality information and the user quality of experience target of the user equipment comprises obtaining the transmission requirement of the media data stream of the user equipment according to: the media quality information, the play status information of the user equipment, and the user quality of experience target of the user equipment.

10. The method according to claim 9, wherein the media play status information comprises allowable play time of media temporarily stored by a player of the user equipment, and wherein obtaining the transmission requirement of the media data stream of the user equipment according to the media quality information, the play status information of the user equipment, and the user quality of experience target of the user equipment comprises:
calculating, according to the media quality information, the maximum user quality of experience that the media data stream can reach; and
obtaining the delay requirement of the media data stream of the user equipment according to the allowable play time of the media temporarily stored by the player of the user equipment, the user quality of experience target, and the maximum user quality of experience.

11. An apparatus for transmitting media data, wherein the apparatus comprises:
a media quality information acquiring module configured to acquire media quality information, wherein the media quality information indicates media quality of a media data stream;
a user quality of experience target acquiring module configured to acquire a user quality of experience target of a user equipment;
a media data delay calculating module configured to obtain a transmission requirement of the media data stream of the user equipment according to the media quality information obtained by the media quality information acquiring module and the user quality of experience target of the user equipment obtained by the user quality of experience target acquiring module; and
a sending module configured to send, to a data node, the transmission requirement of the media data stream of the user equipment obtained by the media data delay calculating module, so that the data node sends the media data stream to the user equipment according to the transmission requirement of the media data stream of the user equipment.

12. The transmission apparatus according to claim 11, wherein the media quality information acquiring module comprises:
a receiving unit configured to receive a media presentation description file from a server; and
a parsing unit configured to parse the media presentation description file received by the receiving unit to obtain media quality information of each video segment of each code stream in the media data stream.

13. The transmission apparatus according to claim 11, wherein the media quality information acquiring module comprises:
a receiving unit configured to receive the media data stream; and
a parsing unit configured to parse the media data stream received by the receiving unit to obtain the media quality information of the media data stream.

14. The transmission apparatus according to claim 11, wherein the user quality of experience target acquiring module is further configured to acquire the user quality of experience target of the user equipment by means of negotiation with the user equipment.

15. The transmission apparatus according to claim 11, wherein the user quality of experience target acquiring module is further configured to acquire the user quality of experience target of the user equipment according to preset subscription information of the user equipment.

16. The transmission apparatus according to claim 11, wherein the transmission requirement comprises at least one of the following: a delay requirement and a packet loss requirement.

17. The transmission apparatus according to claim 16, wherein when the transmission requirement comprises the delay requirement, the media data delay calculating module is further configured to:
calculate, according to the media quality information, maximum user quality of experience that the media data stream can reach; and
obtain the delay requirement of the media data stream of the user equipment according to the user quality of experience target and the maximum user quality of experience.

18. The transmission apparatus according to claim 16, wherein when the transmission requirement comprises the packet loss requirement, the media data delay calculating module is further configured to:
calculate, according to the media quality information, maximum user quality of experience that the media data stream can reach; and
obtain the packet loss requirement of the media data stream of the user equipment according to the user quality of experience target and the maximum user quality of experience.

19. The transmission apparatus according to claim 11, wherein the apparatus further comprises a user play status information acquiring module configured to acquire play status information of the user equipment, and wherein the media data delay calculating module is further configured to obtain the transmission requirement of the media data stream of the user equipment according to: the media quality information, the play status information of the user equipment, and the user quality of experience target of the user equipment.

20. The transmission apparatus according to claim 19, wherein the media play status information comprises allowable play time of media temporarily stored by a player of the user equipment, and wherein the media data delay calculating module is further configured to:
calculate, according to the media quality information, the maximum user quality of experience that the media data stream can reach; and
obtain the delay requirement of the media data stream of the user equipment according to the allowable play time of the media temporarily stored by the player of the user equipment, the user quality of experience target, and the maximum user quality of experience.
